(19) United States
(12) Patent Application Publication
(10) Pub. No.: US 2006/0240796 A1
(43) Pub. Date: Oct. 26, 2006

(54) System for processing signals received and transmitted by a radiocommunication apparatus comprising two modules, and corresponding module and device

(75) Inventors: Gregory Fron, Coubert (FR); Thierry Lapousterlo, Paris (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Wavecom, Issy-Les-Moulineaux Cedex (FR)

(21) Appl. No.: 10/545,933

(22) PCT Filed: Feb. 18, 2004
(86) PCT No.: PCT/FR04/00386

§ 371 Date: May 12, 2006

(30) Foreign Application Priority Data
Feb. 18, 2003 (FR) 03/02112

(51) Int. Cl. H04B 1/16

(52) U.S. Cl. 455/334

(57) ABSTRACT

A system for processing signals received and transmitted by a radiocommunication apparatus comprising two modules and to the corresponding module and device. The system includes signal-processing means distributed between two different modules and each of said modules comprises at least two components on a substrate in a case which is designed to be mounted on a printed circuit, said modules exchanging intermediate signals on an interface provided for said purpose.

### DOMAIN OF THE INVENTION

The domain of the invention is radiocommunications and more precisely digital radiocommunication terminals, either radiotelephones or devices or means of any type capable of exchanging signals using a radiocommunication system, for example implanted in machines or vehicles.

More precisely, the invention relates to manufacturing of these terminals and particularly their miniaturisation and optimisation of their assembly and design as a function of needs.

### PRIOR ART

Component Based Devices

Most radiocommunication devices conventionally include a set of electronic components implanted on a printed circuit. The purpose of these different components is to perform the different necessary functions from reception of RF signal to generation of an audible signal (in the case of a radiotelephone) and vice versa. Some of these functions are analogue and others are digital.

A great deal of research has been carried out on manufacturing of these radiocommunication devices. Three objectives have to be achieved which are difficult to reconcile: to miniaturise devices, to increase the number of features and to simplify assembly. In particular, it is known that implantation of the different components on the printed circuit is a relatively complex operation, since many components have to be put into place on an increasingly small area due to miniaturisation requirements.

Therefore the design of these systems is complex because it also requires that various components, frequently from multiple sources should be combined and made to operate together, while respecting the specific features of each. Furthermore, after all components have been assembled, frequently long and complex calibration test phases are necessary to guarantee correct operation of the device.

Finally, despite the reduction in size of some components, the assembly occupies a certain area, which is difficult to reduce.

Module Based Devices

The holder of this patent application has proposed an approach overcoming some of these disadvantages, consisting of grouping all or at least most of the functions of a digital radiocommunication device in a single module.

Such a module is in the form of a single compact case, preferably shielded, that device manufacturers can implant directly without needing to take account of a multitude of components.

This module, sometimes called a “macro-component” is formed from a group of several components on a substrate so that it can be implanted in the form of a single element. It comprises the components and software essential for operation of a telecommunication terminal using radioelectric frequencies. Therefore, there are no longer any complex conceptual design or validation steps for the terminal. All that is necessary is to reserve the space necessary for the module.

Therefore such a module can easily, quickly and optimally integrate all components into wireless terminals (portable cell telephones), modems or any other application using a wireless standard).

Furthermore, since the module contains all essential functions and was designed as a complete unit, calibration and test problems no longer arise in the same way, or at least are very much simplified.

Thus, modules distributed by the holder of this patent application are fully tested both in terms of hardware and software on most networks on which they might be used later. Furthermore, the module advantageously encompasses industrial property aspects (since all functions are grouped together, the module manufacturer manages the corresponding industrial property rights) and technical assistance aspects.

### DISADVANTAGES OF PRIOR ART

Despite these undeniable advantages, this technique does have some disadvantages. Firstly, the module takes up a certain amount of space because it has to include all the functions. Therefore, it is consequently difficult to implant some small and/or innovative devices.

This relatively large size and the corresponding weight can also cause problems in automatic assembly lines that are not designed for such modules.

Furthermore, its manufacturing is relatively complex since all functions have to be integrated, and for example complete shielding is necessary particularly due to the presence of RF signal processing.

Finally, the structure consisting of grouping all functions is not always adapted to the requirements of some radiocommunication device manufacturers who may wish to use functions that they have developed themselves in some cases, or that are supplied by a third party.

### PURPOSE OF THE INVENTION

The main purpose of the invention is to overcome these disadvantages according to prior art.

More precisely, one purpose of the invention is to provide a technique for optimising manufacturing of radiocommunication devices, and particularly for miniaturising them even further or adapting new forms, while maintaining the advantages provided by modules proposed by the holder of this patent application, and avoiding the disadvantages of conventional systems using multiple components.

Thus, one purpose of the invention is to provide such a technique making it easy for manufacturers of radiocommunication devices to design these devices that are also easy to install, to calibrate and/or to test.

Another purpose of the invention is to provide such a technique offering a good signal processing quality, and particularly good resistance to noise and interference due to RF signals.

Another purpose of the invention is to provide such a technique enabling fast and inexpensive assembly of radiocommunication devices.

Another purpose of the invention is to simplify the development and modification of the means used, and stock management.

### MAIN CHARACTERISTICS OF THE INVENTION

These objectives and others that will become clearer after reading the following, are achieved according to the invention using a system for processing signals received and emitted by a radiocommunication device, for which the signal processing means are distributed in two distinct modules each comprising at least, in a package designed to be mounted on a printed circuit, two components on a substrate exchanging intermediate signals on an interface provided for this purpose.

Thus, the distribution of modules in a device can be optimised, and therefore new products and new shapes can be developed.

Furthermore, each module may be smaller (and therefore more easily handled by machines), and made using the most adapted technologies.

Development of each module is also simplified and faster. It is also easier to modify one or other of the modules.

This makes it easier to manage variants and therefore stocks. For example, for a single baseband module, it would be possible to have several RF modules corresponding to different frequency bands.

According to one advantageous embodiment of the invention, the said intermediate signals are digital signals.

This makes it possible to efficiently reduce interference and therefore keep the advantages of a single module. In this way, it is also possible to keep the two modules away from each other if necessary.

However in some special cases, it is possible that some intermediate signals remain in analogue.

According to one preferred embodiment, a first module performs radiofrequency processing and a second module performs baseband processing.

This decomposition efficiently optimises each module. Preferably, each of the said modules comprises a memory.

A memory can thus advantageously be provided in the RF module (which is essentially analogue) particularly so that it keeps its calibration parameters.

Furthermore preferably, power control and/or frequency reference information is generated and used in the said first module.

This thus limits the number of signals on the interface and this module is made more independent.

According to one advantageous characteristic, at least some of the said intermediate signals of at least one of the said modules are distributed on at least two outputs from the said module so as to optimise the placement flexibility of the said modules.

Thus, particularly when one of the said modules carries an antenna or an antenna output, the said intermediate signals may be available at the right and left of the first module, the antenna or the antenna output remaining in the same direction.

According to one advantageous manufacturing method, at least one of the said modules is made on a ceramic support.

Preferably, one of the said modules made from ceramic integrates surface acoustic wave (SAW) filters.

Advantageously, at least one of the said modules made from ceramic integrates heat dissipation means of a power amplifier.

According to another advantageous aspect of the invention, at least one the said modules includes means of identification of a batch number to which it belongs.

In particular, the said identification means can use short circuits and/or open circuits on some connections of the said module.

It would also be possible for at least one of the said modules to include at least one passive component belonging to the group comprising capacitors, inductors and resistors, the value(s) of which form the identification means.

The said modules can also advantageously include means to verify that they are matched. This prevents the assembly of two modules that are not designed to operate together.

Thus advantageously, a first of the said modules comprises one code and a second of the said modules comprises a key that decodes the said code.

The key can then be transmitted to the module with the code that is blocked if the key is not right. More generally, the modules can exchange encrypted data relating the operation of one to the operation of the other.

In another advantageous aspect of the invention, at least one of the said modules carries shielding.

Preferably, the said shielding carries an antenna or means of holding an antenna.

In particular, the said antenna may include at least one slit forming a radiating structure.

The invention also relates to each module forming such a system and particularly modules comprising radiofrequency processing means and modules comprising baseband processing means.

Preferably, such a module uses a digital interface for exchanging intermediate signals with another module.

The invention also relates to radiocommunication devices using signal processing means distributed in two distinct modules exchanging intermediate signals on an interface provided for this purpose.

As already mentioned, any type of devices onboard a machine (for “M2M”—machine to machine systems), or a vehicle or radiotelephone may be used.

For a radiotelephone, the objective may be to make a telephone comprising two parts free to move with respect to each other, each of the said parts holding one of the said modules.

### LIST OF FIGURES

Other characteristics and advantages of the invention will become clearer after reading the following description of a preferred embodiment of the invention given as a simple illustrative and non-limitative example, and the attached drawings among which:

FIG. 1 shows devices that can use the system according to the invention, namely a radiotelephone with two parts free to move with respect to each other;

FIG. 2 shows a general block diagram of the system according to the invention;

FIGS. 3 and 4 show the principle of each of the modules in FIG. 2, in the form of a simplified block diagram;

FIG. 5 shows a diagram illustrating a module according to the invention with a duplicated connection.

### DESCRIPTION OF A PREFERRED EMBODIMENT OF THE INVENTION

Reminder of the Principle of the Invention

Therefore, the invention relates to a new approach to manufacturing radiocommunication devices based on and improving the known module technique. According to the invention two modules are provided, between which functions usually provided on a single module are distributed. This can optimise the implantation of modules as a function of needs.

Remember that this approach is not obvious, and goes against what an expert in the subject would first expect, considering that the single module is the most efficient solution.

Furthermore, as described in the following, this technique cannot be used efficiently without some non-obvious adaptation such as the use of a digital interface, while RF components and baseband components are conventionally connected together in analogue.

Reminder about the Concept of the Module According to the Invention

In this respect, remember that a module is different from a conventional component in that it includes several components mounted, adapted and tested so as to form an easily implantable assembly, on the same substrate and in the same package.

The presence of two modules according to the invention can maintain and even optimise these advantages while enabling new implantation and assembly possibilities. Smaller modules are obtained that can be handled by logic controllers and can be used to make new products or products with new designs.

Example Embodiment of the Invention: the “Clam Shell” Radiotelephone

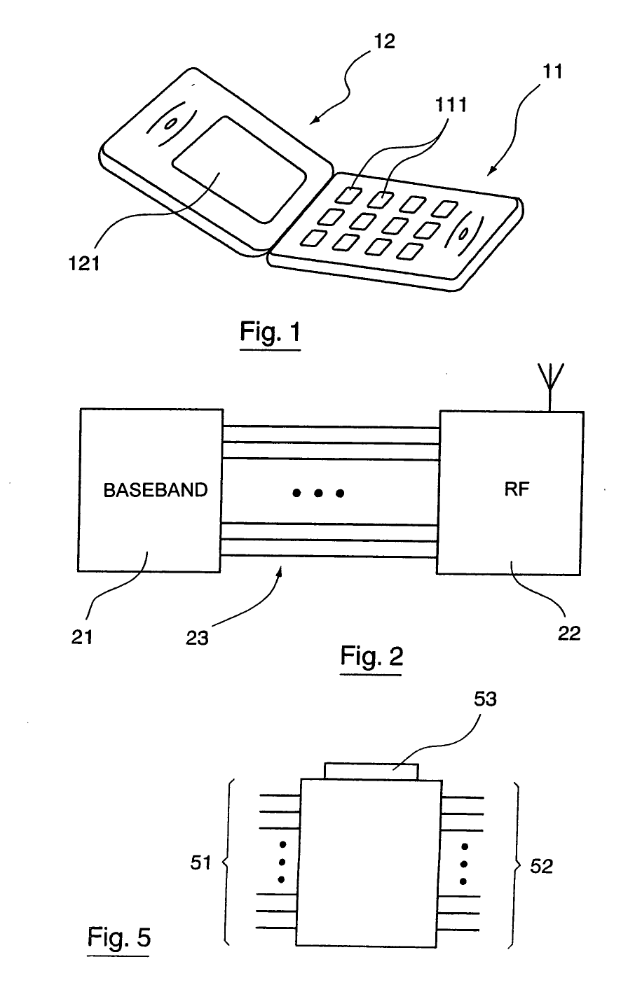

FIG. 1 also shows an example of telephone for which the invention is advantageous. It is a miniaturised radiotelephone made in two parts 11 and 12 free to move with respect to each other, so as to fit together in the closed position and at an angle of the order of 120° to 160° (for example) as illustrated in FIG. 1 (this type of telephone is called a clam shell). The visible parts are in particular the keyboard 111 for part 11 and the screen 121 for part 12.

According to known techniques, the part 11 contains the battery and the module (or major components) on a printed circuit. This is why the part 11 is usually relatively large and thick.

However according to the invention, it is possible to redistribute modules in each of the parts 11 and 12 and therefore particularly to reduce the size of the part 11. The result is thus a much smaller radiotelephone than known telephones, while it maintains all required qualities.

Obviously, many other assemblies and implantations are possible using the two modules according to the invention.

Separation and Interfacing of the Two Modules

FIG. 2 shows a principle diagram according to the invention on which the two modules can be distinguished, between which the different functions have been distributed.

The two modules are called the baseband module 21 and the RF (radiofrequency) module 22. However, note that the distribution of the different functions is significantly different from that used in a single module, in order to optimise each of the modules.

It is also possible to optimise manufacturing of each module, for example by only shielding the RF module 22, or using different substrate technologies best adapted to each module.

Furthermore, the presence of the two modules can move the radio part further away from the baseband part, thus tending to reduce interference generated particularly by the RF module and other active elements of the application.

Separation of the two modules 21 and 22 also improves flexibility in the organisation of other elements of the application. For example, the distance between the antenna and the RF module 22 can be shortened, which can improve the total efficiency and therefore extend the life of the battery.

These two modules 21 and 22 are connected together using a digital interface 23 that also helps to reduce interference and which includes at least the following intermediate logical signals:

serial or parallel link for programming data;

serial or parallel link carrying useful data for processing of data in transmission or reception;

a set of logical control signals;

a reference logical clock.

The Baseband Module

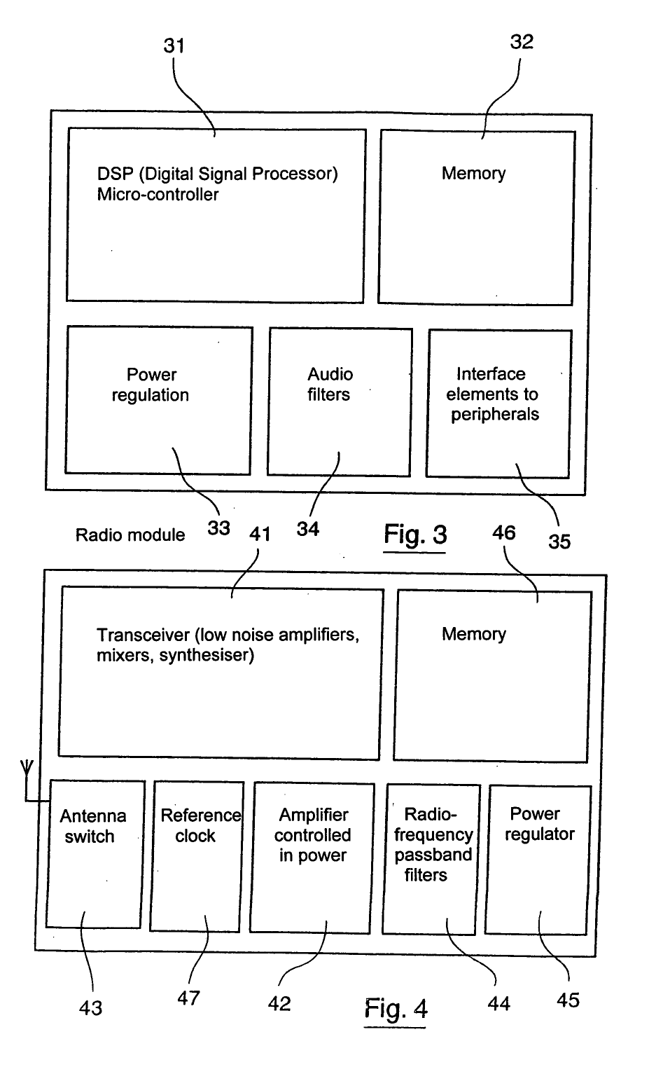

The baseband module 21 is presented in FIG. 3 in the form of a simplified block diagram.

In particular it includes the following components connected to each other and assembled on a single substrate that acts particularly as a mechanical support:

a microprocessor or signal processing processor (DSP) 31, performing the various digital signal processing operations;

a microcontroller 36;

a memory 32;

power regulation means 33;

audio filters 34;

interface elements 35 towards peripherals.

The baseband module 21 thus performs digital processing and therefore must includes software calculation functions and memory areas. Therefore this module is essentially digital.

The RF Module

The RF module 22 is also illustrated in the form of a simplified block diagram. In particular, this module includes the following components connected to each other and assembled on a single substrate that acts particularly as a mechanical support;

a “transceiver” block 41 including low noise amplifiers, a mixer, a low frequency amplifier, a modulator, a demodulator, a frequency synthesiser and an oscillator;

a power controlled amplifier 42;

an antenna switch 43;

RF passband filters, possibly with frequency agility, and for example of the surface acoustic waves (SAW) type 44;

a regulator 45;

a reference clock circuit 47.

This RF module is essentially analogue. However according to the invention, it advantageously includes digital elements, firstly to manage the digital interface and secondly to manage calibration parameters internally. Therefore it includes a memory 46.

Furthermore, the RF module preferably includes power control and frequency reference means, or other calibration elements (that are usually in the baseband digital part of a single module). For example, these parameters are controlled through programming of predefined registers.

This simplifies use of this RF module and reduces the number of intermediate interface signals.

Manufacturing of a Module (Ceramic Support)

According to one advantageous embodiment of the invention in which small modules can be obtained (particularly with reduced thickness), the modules are made on a ceramic substrate.

The RF module 22 includes SAW filters. Specific means are provided for heat dissipation from the power amplifier.

Duplication of Connections

According to one advantageous embodiment of the invention, a multi-input/multi-output system illustrated by FIG. 5 is provided at least for the RF module 22.

The same signals 51 and 52 that interface with the baseband module are duplicated at the right and left of RF module. Thus, by leaving the antenna 53 towards the top of the module, it can be chosen to put the baseband module 21 to the right or left of the RF module 22.

Shielding and Antennas

According to another aspect of the invention, the shielding of the RF module 22 may hold an antenna or act as an antenna (particularly in the case of a double face). It is thus possible to etch a slit or any other appropriate pattern so as to make a radiating structure from it.

The shielding can also be used to fix an attached metallic element acting as an antenna. The shielding is used to protect radio functions in the module from radiation from the antenna and acts as a physical support for the radiating element and itself participates in the radiation.

Another possibility is to extend the substrate (for example ceramic) of the RF module to integrate the antenna into it as illustrated in FIG. 5. In this case, the shielding beginning under the antenna participates in the radio radiation.

Note that these aspects can also be used in the case of a single module.

Identification of the Batch Number

These modules, and for example the RF module 22, can be used for authentication of the batch number by a code using short circuits or open circuits on some connections.

Ceramic is used to etch an electric function (inductor, capacitor and/or resistor) to code a batch number. The identity of the module or the batch number is obtained by measuring the values of components integrated in the substrate, on the inputs/outputs of the module.

Note that these aspects could also be used in the case of a single module.

Example Application

The invention is particularly applicable to modules according to the GSM standard. In this case, modules are guaranteed to be at the GSM standard (FTA). The modules are tested and calibrated independently. Therefore compatibility with the standard is guaranteed on each module and in their grouping in the application independently of each other, due to use of the digital interface.

1. System for processing signals received and emitted by a radiocommunication device,
characterised in that signal processing means are distributed in two distinct modules each comprising at least two components on a substrate in a package designed to be mounted on a printed circuit, and exchanging intermediate signals on an interface provided for this purpose.

2. System according to claim 1, characterised in that the said intermediate signals are digital signals.

3. System according to either of claims 1 and 2, characterised in that a first module performs radiofrequency processing and a second module performs baseband processing.

4. System according to any one of claims 1 to 3, characterised in that each of the said modules comprises a memory.

5. System according to claims 3 and 4, characterised in that memory of the said first module comprises calibration parameters for the module.

6. System according to any one of claims 1 to 5, characterised in that power control and/or frequency reference information is generated in the said first module.

7. System according to any one of claims 1 to 6, characterised in that at least some of the said intermediate signals of at least one of the said modules are distributed on at least two outputs from the said module, so as to optimise the placement flexibility of the said modules.

8. System according to claim 7, characterised in that one of the said modules carries an antenna or an antenna output, and in that the said intermediate signals are available at the right and left of the first module, the antenna or the antenna output remaining in the same direction.

9. System according to any one of claims 1 to 8, characterised in that at least one of the said modules is made on a ceramic support.

10. System according to claim 9, characterised in that one of the said modules made from ceramic integrates surface acoustic wave (SAW) filters.

11. System according to either of claims 9 and 10, characterised in that one of the said modules made from ceramic integrates heat dissipation means of a power amplifier.

12. System according to any one of claims 1 to 11, characterised in that at least one of the said modules includes means of identification of a batch number to which it belongs.

13. System according to claim 12, characterised in that the said identification means use short circuits and/or open circuits on some connections of the said module.

14. System according to either of claims 12 and 13, characterised in that at least one of the said modules includes at least one passive component belonging to the group comprising capacitors, inductors and resistors, the value(s) of which form identification means.

15. System according to any one of claims 1 to 14, characterised in that the said modules comprise means to verify that they are matched.

16. System according to claim 15, characterised in that a first of the said modules comprises one code and a second of the said modules comprises a key that decodes the said code.

17. System according to any one of claims 1 to 16, characterised in that at least one of the said modules carries shielding.

18. System according to claim 17, characterised in that the said shielding carries an antenna or means of holding an antenna.

19. System according to claim 18, characterised in that the said antenna includes at least one slit forming a radiating structure.

20. Module of a system according to any one of claims 1 to 19, characterised in that it comprises radiofrequency processing means.

21. Module of a system according to any one of claims 1 to 19, characterised in that it comprises comprising baseband processing means.

22. Module according to either of claims 20 and 21, characterised in that it uses a digital interface for exchanging intermediate signals with another module.

23. Radiocommunication device, characterised in that it uses signal processing means which are distributed in two distinct modules exchanging intermediate signals on an interface provided for this purpose.

24. Radiocommunication device according to claim 23, characterised in that it is a radiotelephone.

25. Device according to claim 24, characterised in that it comprises two parts free to move with respect to each other, and in that each of the said parts receives one of the said modules.
